(19) United States
(12) Patent Application Publication
(10) Pub. No.: US 2012/0066345 A1
(43) Pub. Date: Mar. 15, 2012

(54) EMERGENCY COMMUNICATIONS PLATFORM

(76) Inventors: Cyril Rayan, San Jose, CA (US); William Curtis O'Linger, Coeur d' Alene, ID (US)

(21) Appl. No.: 13/231,831

(22) Filed: Sep. 13, 2011

Related U.S. Application Data
(60) Provisional application No. 61/382,911, filed on Sep. 14, 2010.

(51) Int. Cl. G06F 15/16

(52) U.S. Cl. 709/218

(57) ABSTRACT

An emergency communications platform and method includes a server having a mass storage device. Storage locations in the mass storage device are provided for a system for anonymous two-way communication, an aggregator, a portal, and an administration console connected for bidirectional data communication with the server and the Internet. The aggregator is adapted for receiving information sent over the Internet, categorizing the received information, and selectively sending categorized information to the portal. Authorized subscribers may view portal information and add new information to the portal. Information sent from reporters is collected, examined, and categorized by the aggregator before selectively being posted in the portal.

### CROSS REFERENCE TO RELATED APPLICATIONS

This application claims the benefit of U.S. Provisional Application No. 61/382,911, filed Sep. 14, 2010 and incorporated herein in its entirety.

### FIELD OF THE INVENTION

Embodiments of the invention relate to a system and method for collecting, prioritizing, and disseminating information related to an emergency event.

### BACKGROUND

An Emergency Operations Center (EOC) collects information related to an emergency and coordinates responses to the emergency by other organizations, governmental entities, public safety organizations, and community groups. An EOC may be organized into groups, with an operations group tasked with deploying physical and human resources in other organizations, a logistics group for coordinating availability of tools, equipment, and people, a planning and intelligence group for collecting, processing, and prioritizing information, a finance and administration group for budgetary activity, and a management group for overseeing and coordinating the efforts of the other groups. In a regional emergency affecting a community or geographic region, many different sources of information may be monitored by an EOC and many different agencies may be involved in responding to the emergency. Some examples of regional emergencies which may be the target of activities by an EOC include natural disasters such as floods, storms, and earthquakes. Other regional emergencies may be related to epidemics, airplane crashes, hazardous chemical releases from industrial or transportation accidents, large fires, loss of utility services, and so on. Or, a regional emergency may be related to deliberately threatening or destructive activity, for example terrorist attack.

In a regional emergency, it may be necessary for an EOC to monitor the status, resources, and efforts of many different organizations, such as fire and police departments, medical first aid and transportation services, water, gas, telephone, and electric utilities, decontamination facilities, and hospitals. Civilian organizations may also participate, for example companies providing heavy equipment, search and rescue teams, and community emergency response volunteers. City, state, and federal government offices may also have an interest in monitoring events related to an emergency and participating in response efforts.

The actions taken by an EOC and other organizations under the direction of the EOC are likely to be most effective when based on the latest available accurate information. In addition to conventional communication methods such as telephone, two-way radio, and email, it is becoming more common for an EOC to receive information directly from community members and first responders who post reports and photographs on a dedicated Internet website. In some cases, information presented on the website may be updated by the members of the target audience. A website may include a map for showing the geographic location of an incident in an event comprising many individual incidents. For example, websites have been created to show hotspot locations in forest fire events. Other websites have been created for reporting location and other information on local outbreaks in a region affected by an epidemic.

For an EOC, one of the benefits a website may offer is “crowdsourcing”, that is, receiving information into a website directly from a community affected by an emergency event. Crowdsourced information may include more local information and may present information more quickly than information passed through formal pathways. However, a website receiving information by crowdsourcing may suffer from any of several known problems. For example, it may be necessary to update a website through a particular communications channel, for example by calling an emergency telephone number or entering information into a website. The channel may be overwhelmed by a large number of incoming message attempts, or the channel may be made unavailable by a direct effect of the emergency event. A person who desires to make a report on an incident may not know which communication channels are being monitored by an EOC, may not have access to a monitored channel, or may not know if any action has been taken on a submitted report.

A member of a community affected by an emergency may choose to give information to a news service such as a television station or a radio station instead of passing the information to an organization managed by an EOC. News media actively solicit information about events and incidents from members of affected communities. As a result, an EOC may be in competition with news media for access to information. Such information may be more current than information known to an EOC and would therefore be valuable to the EOC for planning and executing responses to an emergency.

A website may have other problems limiting its usefulness to an EOC for two-way communication. A person who wishes to make a report may have an incentive for making the report anonymously and may avoid submitting information where a source of a report may be identifiable. A system for anonymous two-way communication may therefore encourage the submission of reports from members of a community affected by an emergency. An example of a system for anonymous two-way communication is disclosed in the U.S. patent application titled “System and Method for Two-Way Anonymous Communication”, Ser. No. 12/645,347, filed on Dec. 22, 2009 by Rayan and O′linger, and incorporated herein in its entirety. However, systems for anonymous two-way communication have not previously been adapted for operation with websites used by EOCS for collection of information related to emergency events. Instead, known websites may make reports from community members publicly accessible. Furthermore, known websites may not distinguish information received from an unqualified source, for example an untrained observer, from a report from a skilled, experienced field responder who has information that may be of great value to other field responders.

An incident report may be posted in a publicly viewable area on a website without authentication of the information or without any judgment as to whether the posted report is in the public interest. For example, a report on a website may be misinterpreted by members of the public, leading to further incidents, panic, evacuation in an unsafe, overcrowded, or blocked direction, or some other undesirable response. Furthermore, it may be difficult for responders in the field to receive information from a website, whether or not the information has been validated and authenticated. Also, validation, categorization, and prioritization of information in a website may cause a substantial time delay between receiving information and an EOC sending information out to field responders. As a result, field responders may take action based on obsolete or incorrect information, potentially increasing risks to themselves or members of the affected community.

### BRIEF DESCRIPTION OF THE DRAWINGS

FIG. 1 illustrates an example of an emergency communications platform in accord with an embodiment of the invention, and further illustrates interactions between the emergency communications platform and other entities who may participate in communications with an EOC during an emergency event.

FIG. 2 is a block diagram of an example of a hardware implementation of an emergency communications platform embodiment of the invention which includes a system for anonymous two-way communication.

FIG. 3 illustrates an example of real-time communication.

FIG. 4 illustrates an example of steps for anonymous two-way communication in accord with an embodiment of the invention.

FIG. 5 continues the example of FIG. 4.

### DESCRIPTION

An emergency communications platform is provided for collecting information related to an emergency event from multiple sources, categorizing the information, selectively publishing the information to a portal, and disseminating information from the portal to a selected set of subscribers. An emergency communications platform optionally includes a server adapted for operation of an aggregator, a portal for retaining information received by the aggregator, and a system for anonymous two-way communication for managing some communications between persons in an area affected by a regional emergency and the aggregator.

The following definitions are provided in support of the description of the disclosed embodiments of the invention:

Emergency event: a regional event requiring a rapid response, for example, but not limited to, a flood, an airplane crash, a forest fire, a hurricane, an earthquake, a train derailment, an explosion at an industrial complex, an accidental release of a hazardous chemical, a large oil spill, or a terrorist attack. An emergency event also includes events which have the potential for requiring a rapid response, for example, public gatherings such as political demonstrations, marches, sporting events, parades, and so on.

Incident: a separately identifiable occurrence related to an emergency event requiring a specific local response. An emergency event may be described as a group of related incidents. For example, an earthquake is an example of an emergency event. The collapse of a particular building is an incident in the earthquake emergency event.

Field responder: a person trained in emergency response and available for taking action at the scene of an incident related to an emergency event, for example, but not limited to, a police officer, an emergency medical technician, a firefighter, a person trained in search and rescue, and so on.

Observer: a person with an interest in monitoring responses to an emergency event, but not directly involved in response operations, for example, a liaison in a mayor's office.

Reporter: a member of a community affected by an emergency event who has information related to an incident or to the broader event in general. A reporter may be, for example, a member of the general public in a geographic region affected by a natural disaster. A reporter may also be a member of a Community Emergency Response Team (CERT). A reporter may have less emergency response training than a field responder, and may be essentially untrained.

Subscriber: an authorized user of an embodiment of the invention, that is, an authorized user of an emergency communications platform. Subscribers are selectively authorized to view information collected by an aggregator and subsequently published to a portal. The terms “aggregator” and “portal” are described in material to follow.

Director: a member of an EOC with responsibility for making decisions on response prioritization, human resource and material resource allocation, information conveyed to the affected community, and so on.

Embodiments of an emergency response platform comprise a redundant communications system having an aggregator and a portal. The aggregator searches for and receives information from multiple Internet-accessible sources, such as social networking services, websites presenting news reports in the form of text, video, or photographs, RSS feeds, communications from field responders, email, and SMS and MMS instant messaging. An aggregator may optionally execute search rules for selecting data to be considered for inclusion in a portal. Alternately, a person may review information received by an aggregator and make a decision as to which information is to be included in a portal. In some embodiments of an aggregator, the aggregator is segregated into separate interfaces with each interface directed at receiving information from a selected information source.

An aggregator optionally examines received information in order to determine if the information is related to an incident for the emergency event that is the focus of a particular implementation of an emergency response platform. In some embodiments of an aggregator, a separate tab in a portal web page display is assigned for each information source. For example, information received from a selected social networking service may be presented on one tab, and information received from a television station may be presented on a different tab.

Incident information is then categorized and mapped by the aggregator. Categories may be adapted to the nature of a particular emergency event. For example, some categories may be related to a meaningful time division in an emergency event, such as beginning of the event, event in progress, selected reporting intervals such as hourly, daily, or weekly reports, return to normal conditions, and so on. Other examples of categories include a count of injuries of various types, for example non-critical, critical, or fatal, or categories related to a type of injury or a type of medical assistance required. Or, categories may be assigned to describe extent of property damage or resources required to effect assistance. One will appreciate that many other examples of categories are within the scope of an embodiment of an aggregator described herein.

An aggregator may optionally assign a level of importance to an incident. For example, some incidents may require immediate response. Other incidents may require progressively less rapid responses or may need progressively fewer resources or personnel to effect a response. An example of a sequence of levels of importance includes immediate, critical, high, medium, and low, in order from highest level of importance to the lowest.

An aggregator may further assign a status to an incident. Examples of status include open, assigned, closed, resolved, and presented for information only, although many other status assignments may be useful in a particular emergency event or to a particular organization participating in responses to an emergency event. For example, status of missing persons may be included in an aggregator, and the aggregator may search for information related to a selected list of missing persons. Information on missing persons may be received by, for example, family members, neighbors, search and rescue personnel, evacuation transport providers, medical reception personnel, or even from the person reported missing once he or she is made aware of a search in progress.

An aggregator may optionally include a geographic locator function to create maps of incidents related to an emergency event. Status information, level of importance, and other categorized information may optionally be presented in combination with a mapped location of an incident.

An aggregator may prevent information from being disseminated further. For example, erroneous information, information that may easily misinterpreted by members of a community affected by an emergency event, and information that could cause further incidents may selectively be blocked by an aggregator. An aggregator may optionally prevent information in a portal from being viewed by anyone other than selected subscribers.

Information that has been examined, qualified, and categorized by an aggregator may selectively be posted to a portal. Whereas previously known websites may permit changes to data retained in the website by any member of the website's target audience, a portal is hierarchical in nature, with new information being entered from the aggregator and not directly from reporters, field responders, subscribers, observers, directors, or other persons who may interact with an emergency communications platform embodiment of the invention. More than one redundant copies of a portal may optionally be maintained at separate physical locations so that a single incident or emergency event can not disable an emergency communications platform.

Subscribers to an emergency communications platform may selectively be authorized to view information in a portal. Conversely, some portal content may selectively be made unavailable for viewing by selected subscribers. The portal may optionally issue an automatic notification to a subscriber or selected group of subscribers in response to posting of new information by the aggregator. A portal may be configured to present only a selected subset of categorized information to a subscriber.

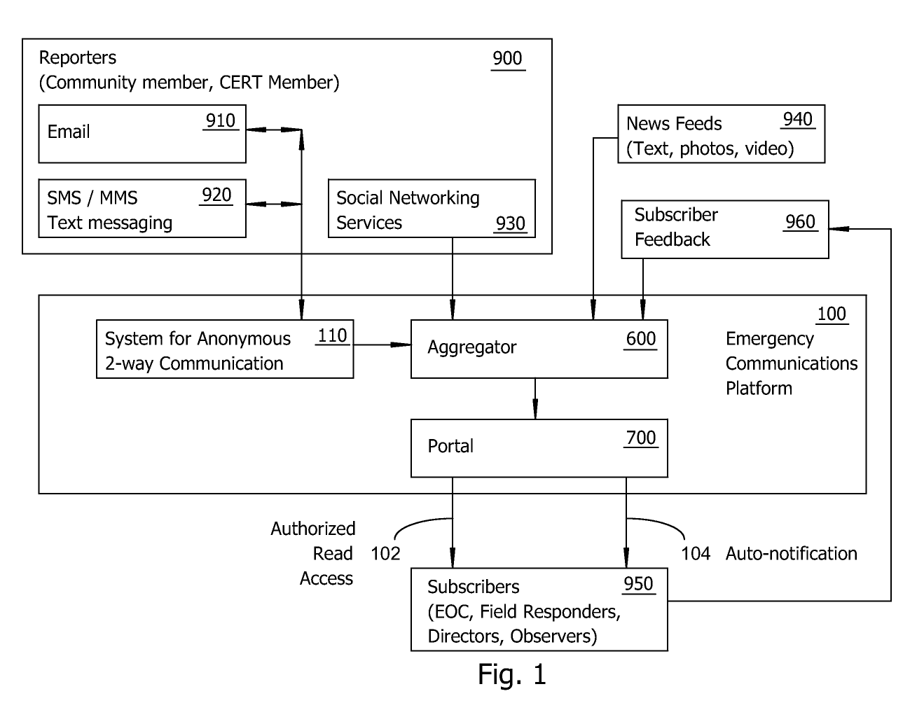

An example of an emergency communications platform 100 in accord with an embodiment of the invention is illustrated in FIG. 1. An embodiment of an emergency communications platform 100 comprises a system for anonymous communication adapted to output data from reporters 900 to an aggregator 600. Reporters 900 may include community members, CERT members, and other relatively untrained personnel in a region affected by an emergency event. Reporters may communicate with the emergency communications platform 100 by email 910 or SMS or MMS text messaging 920 received by a system for anonymous two-way communication 110. Communications between reporters 900 and the emergency communications platform therefore generally take place over the Internet. Other communications into and out of the emergency communications platform 100 may also optionally take place over the Internet. The system for anonymous two-way communication 110 prevents a reporter's identifying address information from being revealed to subscribers of the emergency communications platform 100, unless the reporter chooses to include identifying information in the body of a transmitted message. A message received by the aggregator 600 from the system for anonymous two-way communication 110 is attributed to an alias assigned to a reporter, and not to the reporter's true identity in the form of an identifiable SMS or email address associated with a message. A reporter may also communicate through a social networking service 930. Information passing through a social networking service may optionally be received directly by an aggregator and the information searched for relevance to a selected emergency event, without the information having been anonymized by the system for anonymous two-way communication 110.

The aggregator 600 in FIG. 1 may optionally receive information as news feeds 940 from television stations, radio stations, and other news services in the form of RSS feeds, video feeds, digitized photographs, or text. The aggregator may then optionally examine the received information to determine if the information is related to an incident for the current emergency event. If the information is determined to be relevant, the aggregator may optionally categorize the information, assign status to the information, and enter the information into a portal 700.

Event posted to the portal 700 by the aggregator 600 may be viewed by subscribers 950 having authorized read access 102 to the portal. The portal 700 may optionally be configured to transmit auto-notification messages 104 to a selected group of subscribers 950 when new information is posted to the portal by the aggregator 600. Subscribers, for example EOC staff, field responders, directors, and observers, may optionally post feedback 960 directly to the aggregator 600 without the feedback passing through the system for anonymous two-way communication 110. Subscribers may optionally communicate with reporters 900 anonymously by directing messages to an alias address assigned to a reporter by the system for anonymous two-way communication 110.

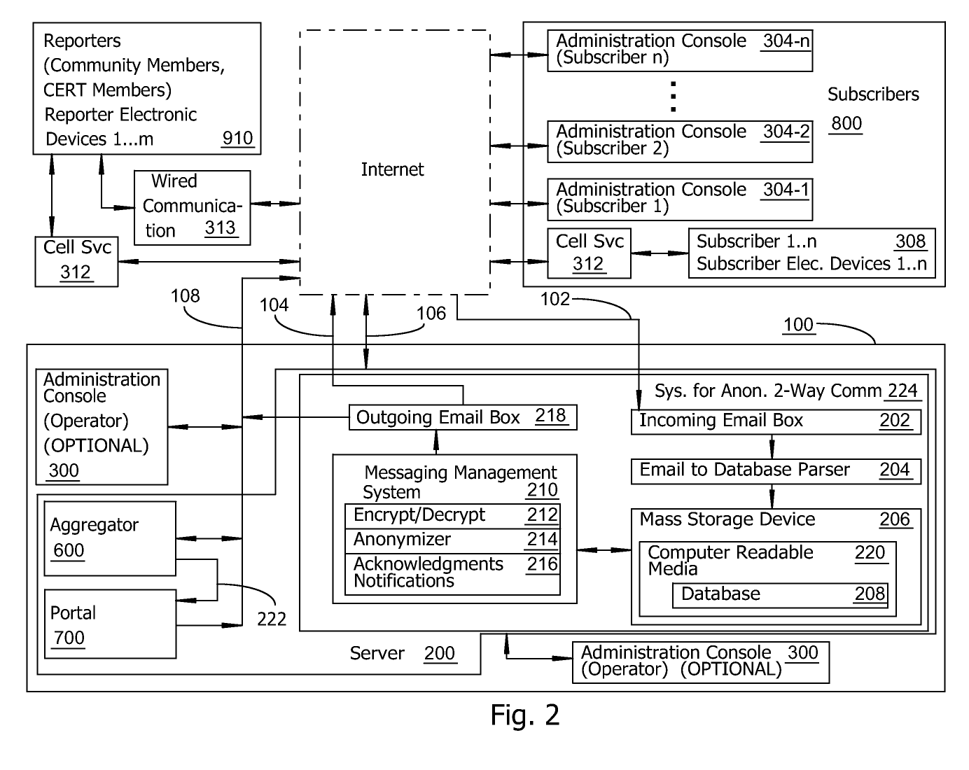

FIG. 2 illustrates an example of hardware systems and components which may be included in an emergency communications platform. In FIG. 2, an emergency communications platform 100 includes a server 200 and an operator administration console 300 connected for data communication with the server 200. The operator administration console 300 is provided for use by an operator responsible for management of the server 200. At least one additional optional subscriber administration console 304 is provided for access to the server 200 by a subscriber. As suggested in FIG. 2 by administration consoles 304-1 to 304-n, up to an integer number “n” of subscriber administration consoles 304 may optionally be connected for data communication with the server 200. Each of the “n” subscriber administration consoles may optionally be separately adapted to the needs and preferences of a particular subscriber. Each of the “n” optional subscriber administration consoles 304 communicate through an Internet communication link 306 to the Internet and thence to the server 200. The operator administration console 300 may alternatively be directly connected to a communications port on the server 200, or be connected to the server through an Internet connection, for example an Internet connection 106 between the server 200 and the Internet. Examples of an administration console suitable for use with an embodiment of the invention include, but are not limited to, a server with a keyboard and display, a desktop computer with a keyboard and display, a portable computer, and a smart phone, that is, a cellular telephone adapted for connection the Internet and including browser software for interacting with Internet web sites.

FIG. 2 illustrates some of the functions performed by subsystems in the server 200. An input connection 102 from the Internet carries data related to email messages received from any one or more of a number from 1 to “n” of separate subscriber electronic devices 308 and other email messages received from any one or more of a number from 1 to “m” of separate reporter electronic devices 910. Examples of electronic systems which may be used to exchange messages anonymously with an embodiment of the invention include, but are not limited to, cell phones having SMS or MMS capability, smart phones, desktop computers, portable computers, game consoles, and other communications-enabled devices. Some of the messages received on the input connection 102 include identifying address information in the sender's address, the destination address, or both. Other messages received on the input connection 102 have a sender's address, a destination address, or both, expressed as aliases.

Messages on the input connection 102 from reporter electronic devices 910 may selectively be received into an incoming email box 202 in a system for anonymous two-way communication 224 residing on the server 200. A system for anonymous two way communication 224 is advantageous for collecting information from reporters who may wish to protect themselves by concealing their identities. Other advantages of an anonymous two-way communication system accord with an embodiment of the invention include sending and receiving anonymous SMS or MMS messages from a cell phone with a low risk of the message being lost en route to its intended recipient, assignment of classification categories to messages, events, activities, and reporters of interest to a particular organization, and capacity for receiving a large number of messages related to an incident or activity reported approximately simultaneously by many different reporters.

Identifying address information refers to a telephone number, for example a cell phone number, a phone number for service provided by the Public Switched Telephone Network (PSTN) or through Voice Over Internet Protocol (VOIP), an email address, an Internet address, a short code corresponding to a phone number, or similar identifying information that is appended to a message to be sent through a wireless or wired communication system for the purpose of identifying the origin and destination of the message. Identifying address information is not intended to refer to information which a reporter or subscriber deliberately inserts into the body of a message, or information in an attachment to a message, such as a person's name, a building address, a vehicle license plate number, and so on, either visible in a photograph or other media attached to a message or included in a document attached to a message.

A message received from a reporter electronic device 910 is placed into an inbox reserved for a selected subscriber according to address information supplied in the destination portion of the received message. A message from a reporter electronic device may be transmitted through a cellular telephone service 312 or a wired communication service 313, then through the Internet, and then to the incoming email box 202. Email messages are then sent to a database parser 204, which separates a received message into parts and enters the separated parts into a database 208 on a mass storage device 206 comprising computer-readable media 220. Some of the actions performed by the database parser 204 include separating the sender's address and recipient's address from the body of the message, and putting these parts into a database record for the message.

The database 208 includes identifying address information for electronic devices communicating with each other through the server 200. A messaging management system 210 performs encryption of data to be stored in the database 208 on the mass storage device 206, in order to make it difficult to access identifying address information in the event of unauthorized access of the database. Encrypted data to be retrieved from the database 208 is decrypted by the messaging management system 210. Data encryption and decryption is performed by an encryption/decryption module 212 in the messaging management system 210.

A unique alias is assigned to each subscriber's administration console 304. A unique alias may optionally be assigned to another electronic device controlled by a subscriber, for example a cell phone adapted for sending and receiving SMS or MMS messages. A subscriber may optionally specify through the subscriber's administration console 304 whether email messages sent from the server 200 are sent only to the subscriber's administration console or are sent to the administration console as email and to another electronic device selected by the subscriber as SMS or MMS messages.

The messaging management system 210 also includes an anonymizer module 214 for forming anonymous messages from incoming messages containing identifying address information. The anonymizer module 214 assigns a unique alias to a first message received from a reporter electronic device 910 under control of a reporter. Subsequent communications with the reporter electronic device 910 refer to the same alias. An outgoing message from the server 200 passes through the anonymizer module 214, where identifying address information related to the intended recipient is substituted for an alias entered by the message's sender. After the recipient's identifying address information is entered into the message, the message is transferred to an outgoing email box 218. From there, the email message, which contains identifying information for the recipient and an alias for the sender, passes through an output connection 104 from the server 200 and then to the Internet. The outgoing message is then delivered to the observer's electronic device.

The server 200 inputs and outputs email messages on its Internet connections (102, 104). A message from a cell phone will be in SMS, or optionally MMS, format. An SMS message sent from an electronic device to the server 200 will be converted to an email message by a cellular telephone service provider. For example, an SMS message from an observer's electronic device, represented by Report Electronic Device 1 . . . m 910 in FIG. 2, is converted to an email message by a cellular service provider 312 in FIG. 2. Similarly, an SMS message sent from a user's electronic device, represented by electronic device 1 308 in FIG. 2, is converted by a cellular service provider 312 to email format for transmission on the Internet. Messages may also be converted from email format to SMS format by a cellular service provider to send an SMS message to a cell phone. Identifying address information related to the observer's cell phone will be converted to identifying address information for sending an email over the Internet by the cellular telephone service provider. An email message sent from the server 200 to a cell phone first has an alias replaced with a corresponding email address in the anonymizer 214, the email is received by the cellular telephone service provider, and the cellular telephone service provider converts the email to SMS or MMS format and sends the message to the observer's cell phone.

Messages passing through the anonymizer 214 are referred to herein as anonymous messages because an electronic device from which a message originates uses an alias as a destination address instead of identifying address information. Identifying address information for the intended recipient of a message is not known to the sender. Similarly, the sender's identifying address information is not known to the recipient, who instead sees the sender's alias, inserted in the message by the anonymizer 214 in the messaging management system 214. Two-way communication between a user and an observer with substitutions of aliases for identifying address information as described herein are therefore referred to as anonymous two-way communication.

In some embodiments of the invention 100, the server 200 evaluates data passing over the Internet connection 106 for the occurrence of a match to one or more predetermined trigger conditions. The occurrence of a match to a predetermined trigger condition causes the Messaging Management System 210 to place a message in the Outgoing Email Box 218. Examples of a predetermined trigger condition include, but are not limited to, a keyword match on a monitored Internet web page, a keyword match on a social networking website, a keyword match in an email message, and a keyword match in an SMS text message. Keywords may optionally be selected by subscribers from Administration Consoles 304-n so that each subscriber may have the Emergency Communications Platform 100 automatically detect a word or phrase and respond with an outgoing message to selected subscribers. For example, a police force or campus security force may automatically monitor a social networking web site to watch for a word or phrase that indicates that an impromptu public gathering (sometimes referred to as a “flash mob”) is about to occur. The server 200 monitors selected sites and sends email messages to authorized subscribers when a match to a key word or phrase is found in data from selected Internet locations.

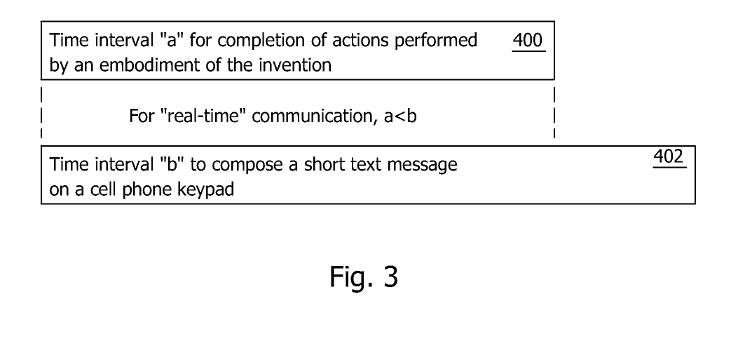

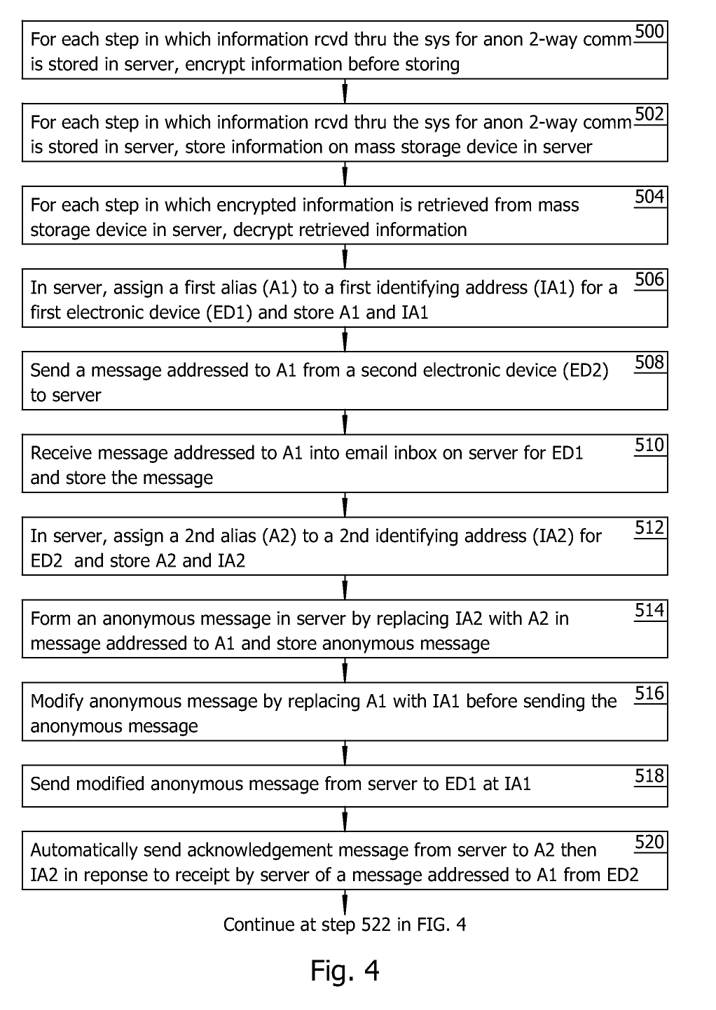

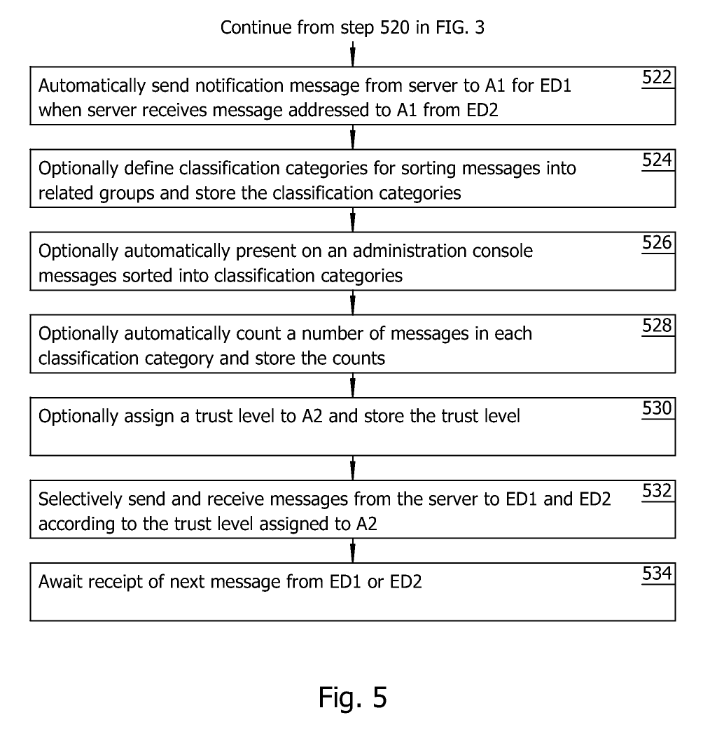

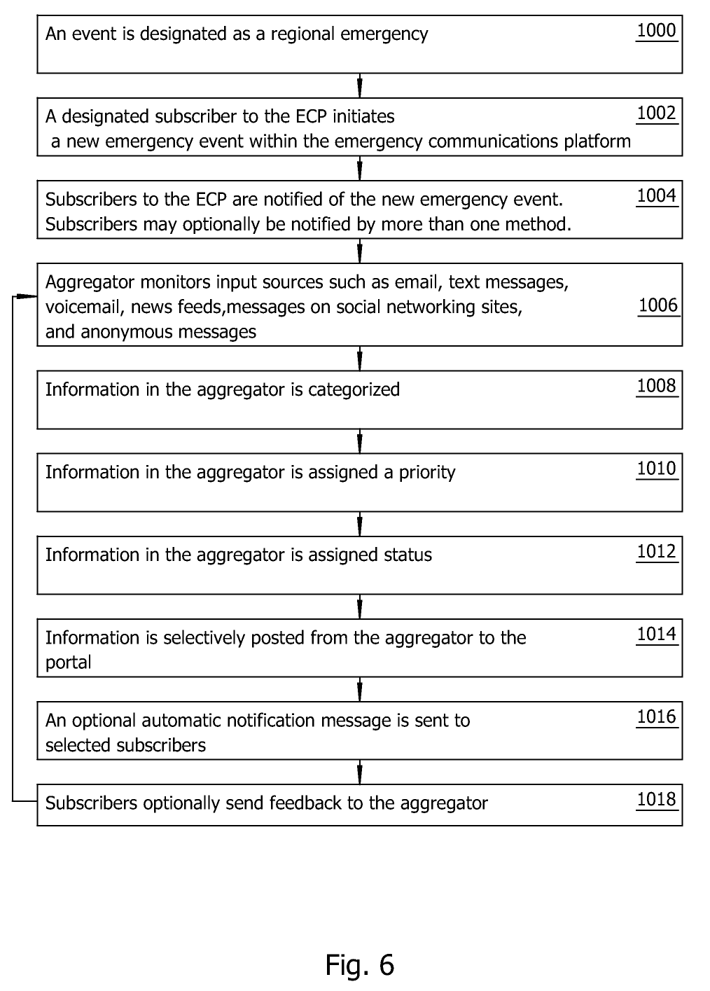

It is an object of the embodiments of the invention to operate in near real time. As used in reference to embodiments of the invention, near real time two way communication refers to a time interval for completion of actions performed by a two-way anonymous communication system that is less than an amount of time for a person to compose a short text message on a cell phone. FIG. 3 illustrates the meaning of near real time in the present context. A time interval “a” 400 corresponds to combined system delays and communication delays in conveying a message from a first electronic device to the server to a second electronic device. A time interval “b” 402 corresponds to an average amount of time required for entry of a short text message, for example a text message comprising approximately 50 text characters using a cell phone's keypad. Communication between two electronic devices through the server component of an embodiment of the invention are considered to be near real time for interval “b” 402 greater than or equal to interval “a” 400. The example of a 50 character text message is not intended to be a firm limiting value for a size of a text message, but is representative of a short but meaningful text message comprising about ten words.

The server 200 in FIG. 2 includes an Aggregator 600 and a portal 700. The aggregator 600 may selectively receive incident data from news feeds and social media services through an Internet connection 108 as previously described in relation to FIG. 1. The aggregator 600 may also receive information sent by reporter electronic devices 910 through the system for anonymous two-way communication 224 residing on the server 200. The aggregator 600 may also receive news feeds, communications through social networking services, and other selected communications directly from the Internet connection 108, without the Internet data having passed through the system for anonymous two-way communication 224.

Entries in the aggregator 600 in FIG. 2 may optionally be categorized and prioritized as previously described. Data in the aggregator related to a selected incident may be posted into the portal directly as suggested by a connection 222 in FIG. 2. Alternately, a decision may be made, either by a set of rules operating in the aggregator or by a person tasked with reviewing incidents and making decisions about what to post in the portal 700, as to whether selected data in the aggregator 600 will be made available to the portal 700. Data in the portal 700 may be accessed through Internet connection 108 by subscribers 800 using administration consoles 304-1 to 304-n, or on subscriber electronic devices 308. In general, viewing of incident data in the portal 700 is restricted to subscribers 800.

The following examples of interactions between various entities who may be involved in an emergency event with an example of an emergency communications platform are provided to illustrate operational aspects of the embodiments of the invention. An emergency event may affect one or more communities within a geographic region. A reporter within the affected community may choose to send information on a specific incident and request action from a field responder. A reporter may also send information to a news media organization. The reporter may communicate by telephone, cellular telephone, smart phone (cellular telephone with Internet communications capabilities), or personal computer. Information communicated by the reporter may include, for example, a text message, email, a voice call to an emergency center or news media, digital photo attached to a message, or video attached to a message. Information may be in the form of, for example, an MMS or SMS text message, voicemail, or direct voice communication.

A communications services provider, for example a cellular telephone service provider, an Internet service provider, or a wired telephone service provider, receives messages, and optionally stores messages, sent by a reporter. Messages received by the communications service provider are forwarded to the emergency communication platform, where the content of the messages is processed by the aggregator and optionally by the system for anonymous two way communication and the portal.

A human operator of the emergency communication platform may selectively examine messages received by the aggregator using the equipment described in FIG. 2. Messages may be in the form of, for example, MMS or SMS messages, text messages, email, voicemail, voice communication, or news media broadcasts. The operator may selectively review incoming information and information in the Aggregator for, for example but not limited to, validity, trustworthiness of the information source, relevance to the current emergency event, priority, and status, and may selectively block the information from being received by the aggregator, selectively block the information from being entered into the portal, or may instead enable to the aggregator to categorize the information, add it to a geographic map, and enter the information into a portal. The human operator may further choose to assign a selected level of trust to a message source, that it, to a reporter's alias, for information received through the anonymous two-way communication system.

A director may selectively review incoming information received by the aggregator, determine the relevance of the reports to a particular incident or to an emergency event, and assign priority, physical resources such as equipment, or human resources to respond to the incident. The director may optionally use a web browser application to view aggregator or portal information using a subscriber administration console as shown in FIG. 2. When a director assigns or changes status information, priority information, or other selected information in a portal, a notification may optionally be sent to selected subscribers, either manually or automatically, by the emergency communication platform.

Some embodiments of the invention comprise steps in a method for anonymous two-way communication. FIG. 4 illustrates an example of steps in accord with an embodiment of the invention.

The example of a method begins with step 500, wherein for each subsequent step in which information received through the system for anonymous two way communication is stored in a server, encrypting information received by the server before storing the information in the server.

Next, in step 502, for each subsequent step in which information received through the system for anonymous two way communication is stored in the server, storing the encrypted information on a mass storage device in the server.

Next, in step 504, for each subsequent step in which encrypted information is retrieved from storage in the server, decrypting information retrieved by the server from the mass storage device in the server.

Next, in step 506, assigning in the server a first alias to a first identifying address for a first electronic device and storing the first identifying address and first alias.

At step 508, the method continues by sending a message addressed to the first alias from a second electronic device to the server.

At step 510, the message addressed to the first alias is received into an email inbox on the server for the first electronic device and storing the message.

At step 512, continue by assigning in the server a second alias to a second identifying address for the second electronic device and storing the second alias and second identifying address.

Next, at step 514, an anonymous message is formed in the server by replacing the second identifying address with the second alias in the message addressed to the first alias and storing the anonymous message.

Next, at step 516, prior to sending the anonymous message, the anonymous message is modified by replacing the first alias with the first identifying address.

At step 518, the method continues by sending the modified anonymous message from the server to the first electronic device at the first identifying address.

At step 520, the server automatically sends an acknowledgment message to the second alias and thence to the second identifying address in response to receipt of a message on the server of a message addressed to the first alias from the second electronic device.

At step 522, a notification message is automatically sent from the server to the first alias, corresponding to the first electronic device, when a message addressed to the first alias has been received by the server from the second electronic device.

At step 524, the method includes the optional step of defining classification categories for sorting messages into related groups.

At step 526, the method includes the optional step of automatically presenting on an administrator console messages sorted into classification categories.

At step 528, the method includes the optional step of automatically counting a number of messages in each classification category.

At step 530, a trust level is optionally assigned to the second alias.

At step 532, messages are selectively sent from the server to the first and second electronic devices according to the trust level assigned to the second alias.

At step 534, the server awaits receipt of a next message from either the first electronic device or the second electronic device.

FIG. 6 illustrates an example of steps in a method for using an emergency communications platform.

At step 1000, an event is designated as a regional emergency.

At step 1002, a designated subscriber to the emergency communications platform (ECP) initiates a new emergency event within the emergency communications platform. A designated subscriber may be, for example, a director at an EOC, a government official, a ranking public safety officer, or some other designated person.

At step 1004, selected subscribers to the emergency communications platform are notified of the new emergency event. Notification may optionally be made automatically in the form of, for example but not limited to, an automated phone call, an email, or a text message, or a member of an EOC member or other designated person may contact subscribers individually. For redundancy of communication, notifications may optionally be made by more than one method.

At step 1006, the aggregator monitors input sources such as email, text messages, voicemail, news feeds, and messages posted on participating social networking sites for information related to the emergency event.

At step 1008, information in the aggregator is categorized.

At step 1010, information in the aggregator is assigned a priority.

At step 1012, information in the aggregator is assigned status.

At step 1014, information is selectively posted from the aggregator to the portal.

At step 1016, an optional automatic notification message is sent by the portal to selected subscribers.

At step 1018, subscribers may optionally send feedback to the aggregator. Examples of feedback include, but are not limited to, status updates, outcomes of actions taken, lessons learned, and so on.

Steps 1006 to 1018 may optionally continue until a director or other designated person determines that the emergency event and related response activities have concluded.

One will appreciate that many alternative embodiments of a method in accord with an embodiment of the invention may be created by performing steps selected from the preceding example in different sequential combinations.

Unless expressly stated otherwise herein, ordinary terms have their corresponding ordinary meanings within the respective contexts of their presentations, and ordinary terms of art have their corresponding regular meanings.

What is claimed is:

1. An apparatus for two-way communication, comprising:
a server having a mass storage device;
storage locations in said mass storage device for a system for anonymous two-way communication, an aggregator, and a portal; and
an administration console connected for bidirectional data communication with said server and the Internet,
wherein said aggregator is adapted for receiving information sent over the Internet, categorizing the received information, and selectively sending categorized information to the portal.
